(19) United States
(12) Patent Application Publication
(10) Pub. No.: US 2004/0054425 A1
(43) Pub. Date: Mar. 18, 2004

(54) Method and apparatus for information conveyance and distribution

(76) Inventor: Glenn Elmore, Santa Rosa, CA (US)

Correspondence Address: JOHNSON & STAINBROOK, LLP, 3550 ROUND BARN BLVD., SUITE 203, SANTA ROSA, CA, 95403, US

(21) Appl. No.: 10/250,625

(22) PCT Filed: May 13, 2002
(86) PCT No.: PCT/US02/15430

(51) Int. Cl. G05B 15/00

(52) U.S. Cl. 700/1

(57) ABSTRACT

The method and apparatus for information conveyance and distribution to bidirectionally focus or guide a wide spectrum of electromagnetic waves propagated over a possible variety of propagation media, including free space or wireless, surface wave, and cable or wired transmission lines. The apparatus communicates with information devices immediately adjacent to these media wherein the devices, which are not themselves part of the apparatus, may have electromagnetic access to one another. The apparatus maintains adequate signal to noise ratio and low distortion for a possible variety of different signal modulation and encoding types which it can support while permitting transparent, simultaneous communications among a variety of devices. Spread spectrum techniques may be used within the apparatus to mitigate propagation medium distortions and impairments as well as to control access and provide a means for securing information within the corridor and for obtaining revenue. Adapters may be employed to provide either full or half duplex access to the information devices which utilize it.

### BACKGROUND OF THE INVENTION

1. Technical Field

The present invention relates generally to the field of wide-area information distribution and high speed data communications, and more particularly to a method and apparatus for information conveyance using electromagnetic carrier signals which provides a high capacity, economical solution to the “last mile problem”.

2. Background Art

As used herein, the following terms bear the respective indicated meanings.

(a) CATV: Community Access Television. Cable TV and similar broadband content systems;

(b) FDA: Full Duplex Adapter, i.e., an adapter which permits simultaneous bidirectional information flow over a propagation medium;

(c) Full Duplex: A type of operation that permits simultaneous communication in both directions;

(d) Half Duplex: A type of operation over a medium designed for duplex operation but which can only be operated in one direction at a time because of the terminating equipment; the transmission facility permits full duplex operation but the terminating equipment does not allow simultaneous bidirectional communication;

(e) HDA: Half Duplex Adapter, i.e., an adapter which permits alternating bidirectional information flow over a propagation medium;

(f) MBE: Multi-Band Embodiment, i.e., a corridor utilizing more than a single spectral bandwidth (normally implemented as a means of supporting bidirectional information flow);

(g) PM: Propagation Medium. The physical medium over which information-carrying electromagnetic waves travel;

(h) PMA: Propagation Medium Adapter, viz., a device used to convert between different propagation media;

(i) SBE: Single-Band Embodiment, a corridor utilizing only a single spectral bandwidth (normally requiring spatial isolation in order to support bi-directional information flow); and

(j) Simplex: A type of operation which permits the transmission of signals in either direction, alternately.

The increasing demand for the rapid, low latency and high volume communication of information to homes and businesses worldwide has made economical information distribution and delivery increasingly important. As demand has escalated, fueled by the widespread adoption of the Internet, the need for economical high speed access by millions of widely dispersed end-users has ballooned as well. Existing systems and networks initially pressed into service for this purpose have proven to be inadequate as requirements have changed. To date, although a number of approaches have been devised and implemented, no single clear solution to this problem has emerged. This disclosure explores the nature of this problem, which has been termed “the last mile problem,” and the characteristics and shortcomings of some of the existing systems that have sought to solve it.

As expressed by Shannon's equation for channel information capacity, the omnipresence of noise in information systems sets a minimum signal power requirement in a channel, even when adequate bandwidth is available. Since information quantity is the integral of rate with respect to time, this requirement leads to a corresponding minimum energy per bit. The problem of sending any given amount of information across a channel can therefore be viewed in terms of sending sufficient information-carrying energy, abbreviated herein as “ICE.” For this reason the concept of an ICE “pipe” or “conduit” is relevant and useful for examining existing systems. ¹C═B*log₂(S/N+1) where C is the maximum rate when an optimum coding technique is employed measured in bits/second, B is bandwidth in Hertz, and S and N are signal power and noise power, respectively.

The distribution of information to a great number of widely separated end users can be compared to the distribution of many other resources. A few familiar analogies include: blood distribution to a large number of cells over a system of veins, arteries and capillaries; water distribution by a drip irrigation system to individual plants, with its supply emanating from rivers and streams; aqueducts and distribution reservoirs, water mains with lateral and feeder mains, house service, and the like; nourishment to a plants leaves through roots, trunk and branches; interstate freeway systems; and intercontinental fiber. All of these examples have in common a plurality of relatively small conduits that carry a relatively small amount of a resource a short distance to a very large number of physically separated endpoints. Also common are conduits supporting more voluminous flow that combine and carry the many individual portions over much greater distances. The shorter, lower volume conduits, which individually serve only one or a small fraction of the endpoints, may have a far greater combined length than the larger capacity conduits.

The high capacity conduits in these systems also tend to have in common the capacity to efficiently transfer the resource over a long distance. Only a small fraction of the resource transferred is either wasted, lost or misdirected. Typically, the same cannot always be said of the lower capacity conduits. One reason has to do with the efficiency of scale: The conduits located closer to the endpoint, or end-user, do not each have as many users supporting them. Further, even though they are smaller, each has the overhead of an “installation,” obtaining and maintaining a suitable path over which the resource can flow. The funding and resources supporting the smaller conduits tend to come from the immediate locale. This can have the advantage of a “small government model.” That is, the management and resources for these conduits is provided by local entities and therefore can be optimized to achieve the best solutions in the immediate environment and to make best use of local resources. However the lower operating efficiencies and relatively greater installation expenses, compared to the transfer capacities, can cause these smaller conduits, on the whole, to be the most expensive and difficult part of the total distribution system.

These characteristics have been evident in the birth, growth and finding of the Internet. The earliest inter-computer communication tended to be accomplished with direct wire line connections between individual computers. These grew into clusters of small Local Area Networks (LANs). The TCP/IP suite of protocols was born out of the need to connect several of these LANs together, particularly as it related to common projects among the defense department, industry, and select academic institutions. ARPANET, the Advanced Research Projects Agency network of the U.S. Department of Defense, came into being to further these interests. In addition to providing a way for multiple computers and users to share a common inter-LAN connection, the TCP/IP protocols provided a standardized way for dissimilar computers and operating systems to exchange information over the inter-network. The funding and support for the connections among LANs could be spread over one or even several LANs, and as each new LAN, or subnet, was added, the new subnet's constituents enjoyed access to the greater network. At the same time the new subnet made a contribution of access to any network or networks with which it was already networked. Thus the growth became a mutually inclusive or “win-win” event. To be sure, there were no doubt situations where the creation of a new connection most benefitted some subnet other than the one actually doing the connecting, but due to the economy of scale and, perhaps, the ability to get economic assistance from the beneficiaries, the connections were made.

In general, economy of scale makes an increase in capacity of a conduit less expensive as the capacity is increased. There is an overhead associated with the creation of any conduit. This overhead is not repeated as capacity is increased within the potential of the technology being utilized. As the Internet has grown in size, by some estimates doubling in the number of users every eighteen months, the economies of scale haves resulted in increasingly large information conduits providing the longest distance and highest capacity “backbone” connections. In recent years the capability of fiber optic cable, aided by a supporting industry, has resulted in a great deal of raw capacity, so much so that in the United States there exists a large amount of “dark fiber,” that is, installed fiber that remains unused because exceeds current needs. In effect, fiber optic capacity has been overbuilt, and the present problem is how to cost-effectively connect from a major switch to end users.

This excess fiber optic backbone capacity exists despite the trend of increasing per-user data rates and overall quantity of data. Initially, only the inter-LAN connections used existing telephone lines, and modems were capable of data rates of only a few hundred bits per second. Now almost all end users enjoy access at one hundred or more times those rates. But in spite of this great increase in user traffic, the high capacity backbones have kept up; the information capacity and rate limitations almost always occur at or near the user. The economy of scale along with the fundamental capability of fiber technology have kept the high capacity conduits adequate but have not solved the appetite of the home users. The last mile problem is one of economically serving an increasing mass of end-users with a solution to their information needs.

Before setting out a brief survey of the characteristics of existing last mile information delivery mechanisms, it is important to examine further precisely what makes information conduits effective. As Shannon's equation shows, it is a combination of bandwidth and signal-to-noise ratio (S/N) which determines the information rate of a channel. The product of the average information rate and time yields total information transfer. In the presence of noise, this corresponds to some amount of transferred energy. Therefore, the economics of information transfer may be viewed in terms of the economics of the transfer of ICE.

Some of the factors important to efficient ICE transfer come directly from Shannon's equation. Effective last mile conduits must: (1) deliver signal power, S, (that is, they must have adequate signal power capacity); (2) have low loss (low conversion to unusable energy forms); (3) support wide transmission bandwidth; and (4) deliver high Signal/Noise ratio.

Additionally, a good solution to the last mile problem must have: (1) adequate signal power capacity; (2) high availability and reliability; (3) low latency (latency must be small compared to required interaction times); (4) high per-user capacity, i.e., a conduit which is shared among multiple end-users must provide a correspondingly higher capacity in order to support each individual user properly (this must be true for information transfer in each direction); and (5) affordability—suitable capacity must be economical.

Existing Last Mile Delivery Systems

Wired Systems (Including Dielectric Guides)

Wired systems provide guided conduits for ICE. They all have some degree of shielding, which limits the susceptibility to external noise sources. These transmission lines have losses which are proportional to length. Without the addition of periodic amplification, there is some maximum length beyond which all of these systems fail to deliver adequate S/N to support information flow.

Local Area Networks, LANs: Traditional wired local area networking systems require copper coaxial cable or twisted pair to be run between or among the nodes in the network. Common systems operate at 10 Mbps and newer ones support up to 100 Mbps. While the maximum length is limited by collision detection and avoidance requirements, signal loss and reflections over these lines also set a maximum distance. The decrease in information capacity made available to an individual user is roughly proportional to the number of users sharing the system.

Telephone—Analog: Analog modems for existing telephone lines have improved to the point that their performance is near the Shannon limit. They normally use existing copper telephone lines and equipment but information rate requirements have now exceeded this limit of around 56 kbps.

Telephone—ISDN, DSL, and derivatives: In recent years, improvements have been made to existing copper telephone lines that have increased their capabilities if maximum line length is controlled. With support for higher transmission bandwidth and improved modulation, these digital schemes have increased capability 20-50 times that of the previous analog systems. Together with CATV, these systems currently provide the bulk of end-user broadband internet connections in the United States.

CATV: Community Access Cable Television Systems, also known simply as “cable”, have been expanded to provide bidirectional communication over existing physical cables. However, by their heritage they are shared systems, and the spectrum available for reverse information flow and achievable S/N is limited. As was the case with the initial unidirectional (TV) communication, cable loss is mitigated through the periodic placement of amplifiers within the system. These factors set an upper limit on the per-user information capacity, particularly when there are many users sharing a common section of cable.

Optical Fiber: Fiber is an excellent medium with respect to its information carrying capacity, but it has the drawback of being installed primarily at the large conduit level; as yet, it is not already installed and readily available to most individual end users. Fiber optic cable is generally laid underground in conduits, requiring a relatively expensive installation which is currently prohibitive for most individual users. Until this situation changes, other media must be utilized to economically solve the last mile problem.

Wireless Delivery Systems

In contrast to wired delivery systems, wireless systems use unguided waves to transmit ICE. They all tend to be unshielded and have some degree of susceptibility to unwanted signal and noise sources. Because their waves are not guided, in free space these systems have attenuation which is inversely proportional to length squared. This means that losses increase more slowly with increasing length than for wired systems. In a freespace environment, beyond some length, the losses in a wireless system are less than those in a wired system. In practice, however, the presence of atmosphere and atmospheric disturbances, and especially obstructions caused by terrain, buildings and foliage, can greatly increase the loss over and above the free space value. Reflections, refraction and diffraction of these waves can also alter their transmission characteristics and require specialized systems to accommodate and correct the accompanying distortions.

Wireless systems have an advantage over wired systems in last mile applications in not requiring physical lines to be installed. However, they also have a disadvantage inasmuch as their unguided nature makes them more susceptible to unwanted noise and signals. Spectral reuse can therefore be limited.

Lightwaves: Both visible and infrared light are of wavelengths greatly shorter than that of radio frequency waves. Because of this, they can be focused or collimated with a smaller lens/antenna and to a much higher degree than can radio waves. In free space, a greater portion of the transmitted signal can be recovered by a receiving device. Also because of the high frequency, a great deal of information bandwidth may be available. However in practical last mile environments, obstructions and de-steering of these beams along with absorption by elements of the atmosphere like fog and rain, particularly over longer paths, greatly restricts their usefulness in last mile wireless communications.

Radio waves: Radio frequencies (RF), from low frequencies through the microwave region, have much longer wavelengths than lightwaves. While this means that it is not possible to focus the beams nearly as much as for light, it also means that the aperture or “capture area” of even the simplest, omnidirectional antenna is greatly larger than that of the lens in any feasible optical system. This characteristic results in greatly reduced “path loss”. In actuality the term path loss is something of a misnomer since no energy is actually lost on a freespace path. The apparent reduction in transmission, as frequency is increased, is actually an artifact of the decrease in the aperture of a given antenna.

With respect to the last mile problem, these longer wavelengths have an advantage over lightwaves when omnidirectional or sectored transmissions are considered. The larger aperture of radio antennas results in much greater signal levels for a given path length and therefore higher information carrying capacity. On the other hand, the lower carrier frequencies are not able to support the high information bandwidths required by Shannon's equation, once the practical limits of S/N have been reached.

For the foregoing reasons, wireless radio systems have the advantage of being useful for lower information capacity, broadcast communications over longer paths, while wireless lightwave systems are most useful for high information capacity, point-to-point, short range communications.

One-Way (Broadcast) Radio and Television Communications: Historically, most high information capacity broadcast has used lower frequencies, generally no higher than the UHF television region, with television itself being a prime example. Terrestrial television has generally been limited to the region above 50 MHz where sufficient information bandwidth is available, and below 1000 MHZ, due to problems associated with increased path loss as mentioned above.

Two-Way Wireless Communications: Two way communications systems have primarily been limited to lower information capacity applications, such as audio, facsimile or radio teletype. For the most part, higher capacity systems, such as two way video communications or terrestrial microwave telephone and date trunks, have been limited and confined to UHF or microwave and to point-point paths. Recent higher capacity systems such as third generation, 3G, cellular telephone systems require a large infrastructure of closely spaced cell sites in order to maintain communications within typical environments, where path losses are much greater than free space and which also require omnidirectional access by the users.

Satellite Communications: For information delivery to end users, satellite systems, by nature, have relatively long path lengths, even for low altitude earth orbiting satellites. They are also very expensive to deploy and each satellite must serve many users. Additionally, the very long paths of geostationary satellites cause information latency that makes many real time applications impractical. Therefore, as a solution to the last mile problem satellite systems have application limitations. For instance, they must be broadcast, and the ICE they transmit must be spread over a relatively large geographical area. This causes the received signal to be functionally weak, unless very large, directional terrestrial antennas are used. A parallel problem exists when a satellite is receiving. In that case, the satellite system must have a very great information capacity in order to accommodate a multitude of sharing users, and each user must have large antenna size, with attendant directivity and pointing requirements, in order to obtain even modest information rate transfer. These requirements render high information capacity, bidirectional satellite information systems uneconomical as a solution to the last mile problem. This is a reason that the Iridium satellite system was unsuccessful.

Broadcast versus Point-to-Point: For both terrestrial and satellite systems, economical, high capacity, last mile communications requires point-to-point transmission systems. (See Elmore, Glenn, Physical Layer Considerations in Building an Amateur Radio Network, Proceedings of the American Radio Relay League Computer Networking Conference, 1988, incorporated herein in its entirety by reference.) Except for extremely small geographic areas, broadcast systems are able to deliver large amounts of S/N only at low frequencies, where there is insufficient spectrum to support a large number of users. While complete “flooding” of a region can be accomplished, such systems have the fundamental drawback that most of the radiated ICE never reaches a user and is thus wasted. As information requirements increase, broadcast “wireless mesh” systems (also sometimes referred to as cells or microcells), which are small enough to provide adequate information distribution to and from a relatively small number of local users, require a prohibitively large number of broadcast locations or “points of presence” along with a large amount of excess capacity to make up for the wasted energy.

Previous attempts to provide high speed and high volume information services to end users have fallen short of the demand. Millions of home and business users worldwide desire high speed internet access for increasingly demanding applications. Other applications and services, both digital and analog, also await faster wide area end user access in order to be more fully developed and utilized. The provision of services that provide audio and video on demand to homes and offices worldwide has been hindered by the lack of high speed information paths to and from potential customers.

Most prior attempts to distribute information have either been application specific or have tried to reuse existing infrastructure for new purposes. Some newer infrastructures, like CATV systems, have provided large information capacity in one direction and required a very large and expensive distribution network. Home and small business internet access was first attempted using existing telephone networks. As the capacity limitations of this previously analog-only hardware were reached, various digital subscriber line (DSL) solutions were attempted, still using the existing telephone lines Similarly, CATV networks have been pressed into service with cable modems in attempt to better solve the information distribution problem. While the one-way, per-user capacity of these systems was greater than conventional telephone systems (referred to as POTS), they were not originally designed for very high speed and very high volume two-way information flow, nor did they all provide dedicated, unique information conduits to each end user. Satellite-based systems have some of the same limitations as CATV systems in this regard. They must be shared among many subscribers and users, which greatly limits the per-user information rates and capacities when serving a multitudes of users.

All prior attempts have fallen short in their ability to provide large bi-directional information capacity to end users in an economical manner, in the form of wide bidirectional bandwidth along with high signal-to-noise ratios.

In summary, no solution to the last mile problem has yet surfaced. No existing system has yet demonstrated efficient and economical ICE transfer using existing wired or wireless techniques which provide sufficient information capacity to meet the present user requirements.

### BRIEF SUMMARY OF THE INVENTION

The method and apparatus for information conveyance and distribution of the present invention may be characterized as an information corridor. It is an object of the present invention to provide an information corridor that comprises a system combining a method and apparatus to bidirectionally focus or guide a wide spectrum or bandwidth of electromagnetic waves propagated over a possible variety of propagation media, including free space or wireless, surface wave and, cable or wired transmission lines. The corridor consists of the region within and immediately adjacent to these media wherein information devices, which are not part of the corridor, may achieve electromagnetic access to one another. A corridor is a linear system which maintains adequate signal to noise ratio and low distortion for a possible variety of different signal modulation and encoding types which it can simultaneously support as it serves to transparently permit communications. As used herein, “transparent” and “transparently” mean that from the end users' perspectives, the obstacles to communication with one another have been eliminated.

Spread spectrum techniques may be used within an information corridor to mitigate propagation medium distortions and impairments as well as to control access and provide a means for securing information within the corridor and for obtaining revenue. An information corridor may include adapters to provide either full or half duplex access to the information devices which utilize it.

The information corridor of the present invention is an implemented and verified approach for improving layer one information capacity to the end user. It allows bi-directional transmission of large portions of spectrum, with significant signal/noise ratio, independent of modulation and protocol, over any combination of several available propagation media. The corridor's information capacity is less than that of optical fiber, but it can be much greater than that of current wireless, cable, or phone line approaches. As such, it is an effective solution to the last mile problem.

This brief summary of the invention and the detailed description of the preferred embodiments of the present invention describe equipment, systems, and their arrangement, which creates an “Information Corridor.” Such a corridor consists of either a single propagation medium (PM), an example of which is shown in FIG. 1, or of a cascade of two or more such PM sections in which each PM is accessed with two or more Propagation Medium Adapters (PMAs), each of which couples energy to and/or from the PM. An example of multiple sections is shown in FIG. 2. In addition to cascades, multiple sections may be combined at a single juncture or node. A section enhances the conveyance of information along itself and/or between its endpoints by propagating electromagnetic energy within one or more contiguous bandwidths of the electromagnetic spectrum (hereafter referred to as bandwidth), supporting substantial S/N in that bandwidth, between and/or among PMAs. Some corridors may support only half duplex information conveyance, but the preferred embodiments support simultaneous multi-directional information conveyance.

As shown in FIG. 1, additional devices providing amplification and/or filtering (hereafter referred to as AMP) are placed between adjacent PMAs operating in the same type or in a different type of PM for the purposes of establishing the bandwidth and of maintaining adequate S/N throughout the corridor.

Additional Full-Duplex Adapter devices (FDAs) may be included for multi-bandwidth embodiments (MBE). MBE allow multiple bandwidths to be utilized to obtain directional separation and provide simultaneous multidirectional information conveyance over a PM. Additional Half-Duplex Adapter devices (HDAs) may be included for multi-bandwidth embodiments not requiring simultaneous bidirectional communication. Embodiments not using MBE and utilizing only a single bandwidth are referred to as single band embodiments (SBE). Additional spread-spectrum circuits may be included in either MBE or SBE to provide spread spectrum (SS) modulation and demodulation to mitigate against narrow frequency domain propagation impairments such as multipath, reflections, or other imperfections which might be present in a PM. SS can also be used to control user access to a corridor, to provide security, and as a means to obtain revenue from corridor users.

An information corridor is configured to enhance the conveyance of information among users' wireless devices (e.g., radio frequency and microwave communications devices) located at physically separate positions along and within the corridor by substantially increasing the information capacity of electromagnetic information channels between and/or among wireless devices. Wireless devices can include, but are not limited to, wireless networking adapters, personal data assistants, computers, audio and video communication systems, security equipment and “smart appliances,” and systems such as Bluetooth devices. Wireless devices may incorporate either digital or analog modulation techniques, or both.

The information corridor of the present invention contributes to several complementary technologies, which can be used independently or synergistically. The inventive information corridor can provide simultaneous support of multiple telecommunications services, including Internet/802.11x, GMS, police radio, traffic monitoring, stop-light control, and so on. It augments fiber-to-the-neighborhood with a true “last mile” solution, allowing the fiber to stop at a coarser level and economically distribute large amounts of information. It is adapted for use in mobile services, telephones, Internet access, and emergency communication services along rural roads and communities. It expands existing shorter-range systems to include multiple building and campus-wide environments (e.g., Bluetooth, 802.11x, etc.). It improves communications through tunnels in metropolitan areas (today's solutions are proprietary and service/protocol specific. Finally, it improves emergency communications in hilly regions with problems maintaining communications with a central radio tower, and for such an application it may be deployed on an as-need basis.

The information corridor of the present invention leverages existing facilities, including power lines, streetlight and utility poles, and cell sites, providing much more capacity than the current power line communication (PLC) techniques, and it does so at a lower cost. It exploits presently allocated and authorized domestic and international frequencies for all information-carrying services, though it embodies the capacity to include any part of the RF and microwave spectrum. Accordingly, it provides a temporary, and possibly permanent, economically advantageous solution to the problem of bringing fiber optic cable to the curb and to the home.

The inventive information corridor also provides an economical solution to the bandwidth over-subscription problems, including xDSL Internet access, over-subscribed orbital satellite communications services, and highly shared Data Over Cable Service Interface Specifications (DOCSIS) back or forward data paths.

Further, the inventive information corridor can have higher throughput than existing protocol-specific solutions. It does not require store&forward of information content, and it has no storage delays. It does not require demodulation/re-modulation of information. It does not exhibit the hidden transmitter problem. Finally, it may incorporate spread-spectrum techniques to mitigate channel distortions and to provide a means for restricting corridor use to an intended (e.g., paying) customer base.

### BRIEF DESCRIPTION OF THE SEVERAL VIEWS OF THE DRAWINGS

FIG. 1 is a schematic illustration of a section of the information corridor of the present invention, having a PMA at each end of the corridor connected to other PMAs, with or without intervening AMP, HDA/FDA or SS circuits;

FIG. 2 is a block diagram of an embodiment of the inventive information corridor comprising three different PMs and including AMP and duplex adapter functions;

FIG. 3 is a schematic view of an information corridor having several types of PMs, light and “heavy” PMA coupling;

FIG. 4 is a detailed schematic view of two interconnected freespace PMs;

FIG. 5 is a detailed schematic view of possible AMP and FDA blocks;

FIG. 6 is a detailed schematic view of a singlewire PMA, AMP, dual-band FDA, and SS;

FIG. 7 is a schematic view of an information corridor with gateways for different types of services;

FIG. 8 is a schematic view of separate information corridors merged at the physical layer to form a single, larger, corridor, as well as some gateway devices;

FIG. 9 is a schematic view of an information corridor implemented to distribute high capacity information services such as streaming audio, streaming video, internet access, “Instant Replay” on demand, telephone and so forth to spectators at a sporting event;

FIG. 10 is a schematic view of an information corridor implemented to distribute services for mobile users and providing coverage in and through tunnels and other closed spaces;

FIG. 11 is a schematic view of an information corridor distributing information services among urban office environments; and

FIG. 12 is a schematic view of an information corridor distributing traditional “last mile” information service to users in a rural area.

### BEST MODE FOR CARRYING OUT THE INVENTION

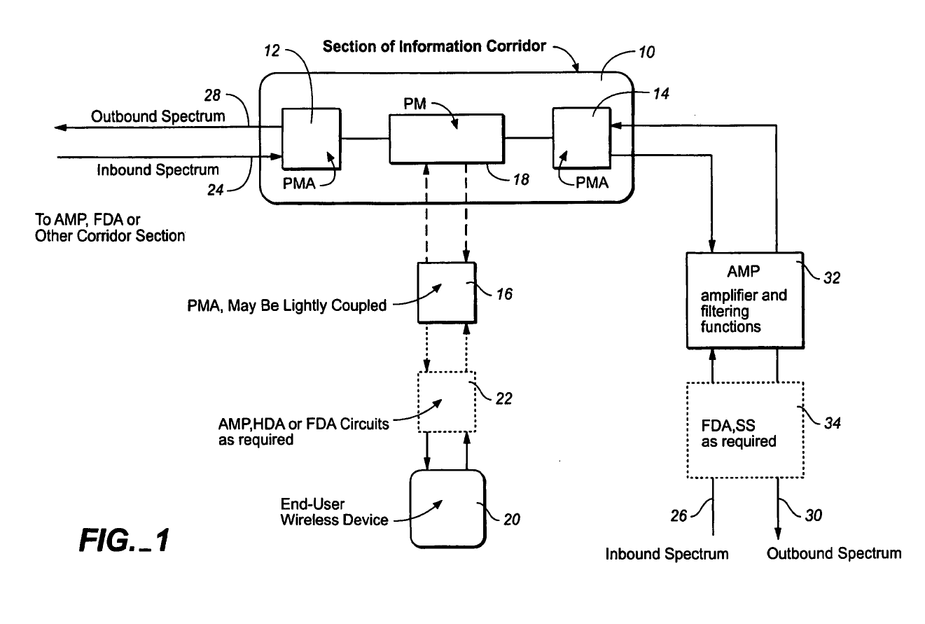

FIG. 1 shows a section 10 of an information corridor of the present invention. A PMA 12, 14, is included at each end, and each can be connected to other PMAs, with or without intervening AMP, HDA/FDA or SS circuits. Also shown is a lightly coupled PMA 16 allowing a wireless device to access the PM 18 at an intermediate point. Because the coupling is light, operation is possible with little or no disruption of the “through traffic” in the form of greatly increased reflections or other transmission impairments. The intermediate PMA 16 accessed by end-user wireless device 20, may included intervening AMP, HDA, or FDA circuits 22, as required. Because communications are bi-directional, inbound spectrum 24, 26, and outbound spectrum 28, 30, are differentiated at each end of the linear system. Again, AMP 32 and FDA, SS circuits 34 may be placed according to system requirements.

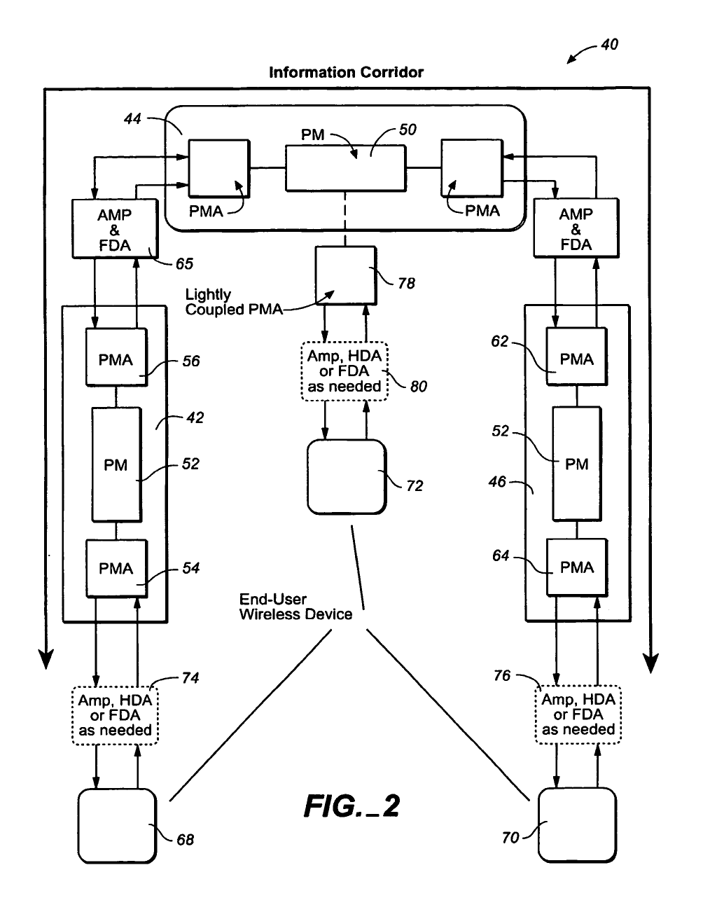

FIG. 2 is a block diagram of a sample information corridor 40 comprised of three different PM/PMA sections 42, 44, and 46, comprised of PMs 48, 50, 52, and PMAs 54/56, 58/60, and 62/64, at each end of their respective PMs. The corridor includes AMP and duplex adapters 64, 66 between each corridor section. SS functions could also be included here. User wireless devices 68, 70, 72, are shown intersecting at various locations, the two end wireless devices 68, 70 having intevening AMP, HDA or FDA devices 74, 76, according to requirements. The intermediate wireless device 72 which accesses PM 50 through a lightly coupled PMA 78, and an AMP, HDA or FDA, 80, or a combination thereof, may be provided as needed.

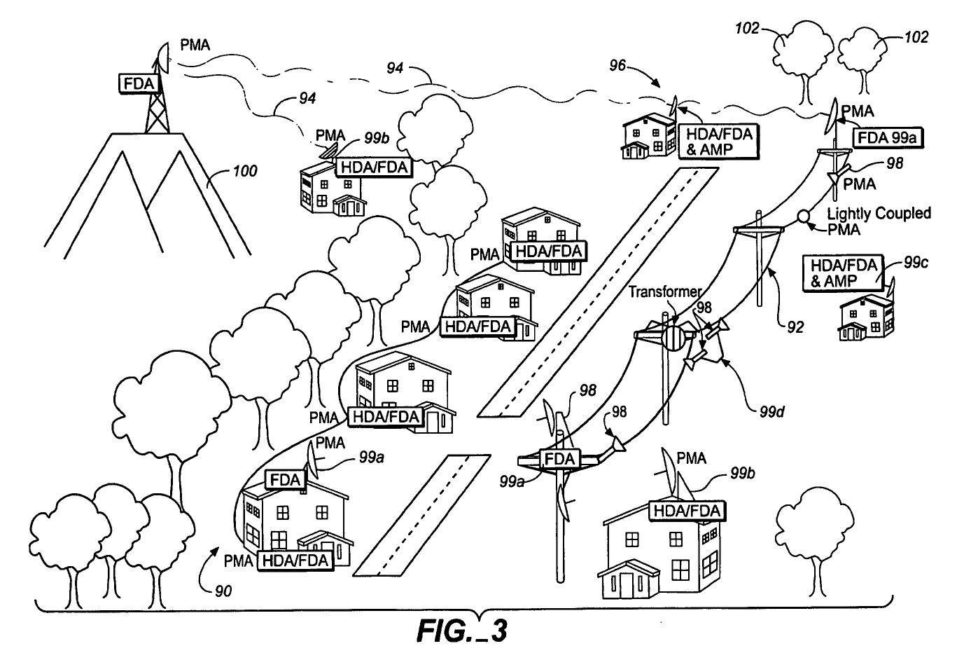

FIG. 3 is a schematic diagram of an information corridor that includes several different types of PMs, including a cable/fiber PM 90, a singlewire PM 92, and a freespace PM 94. Also shown are light PMA couplings 96, heavy PMA couplings 98, PMAs with FDA circuits 99 interposed between the PMA and the end user, PMAs with HDA circuits 99a so interposed, PMAs with both FDA and HDA 99b, PMAs with FDA, HDA and AMP circuits 99c, a cable fiber PM bypass 99d, and the terrain 100 and physical elements, e.g., trees 102, which would greatly limit information communication and distribution if the corridor were not present.

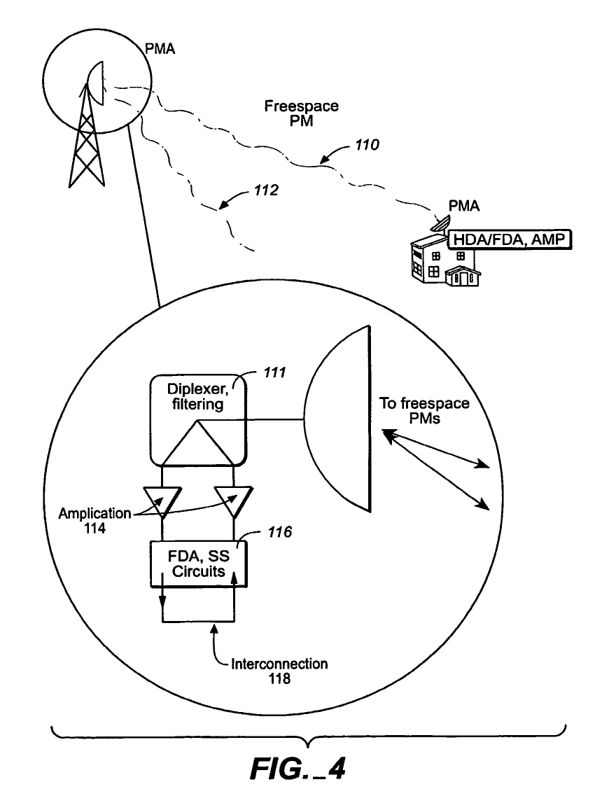

FIG. 4 is a schematic view showing some detail of two interconnected freespace PMs, 110, 112. This view also shows that the PMA includes a diplexer filtering circuit 111, comprising an AMP 114, and FDA and SS circuits 116 having an interconnection 118.

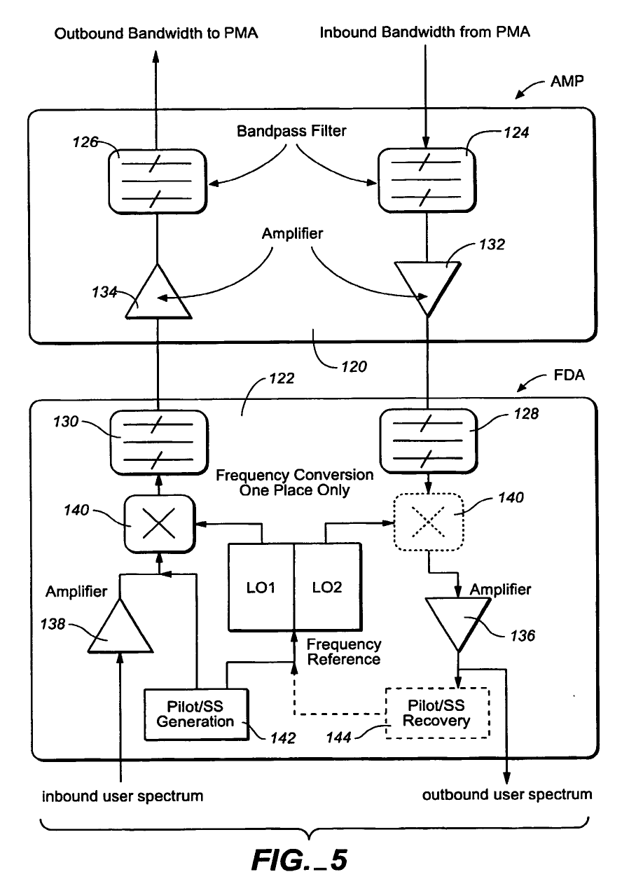

FIG. 5 is a schematic diagram showing detail of possible AMP 120, and FDA blocks 122 placed between an end user and a PMA. AMP bandpass filters 124, 126, along with FDA bandpass filters 128, 130, define and establish operating bands. Amplifiers 132, 134, 136, and 138, maintain high S/N on inbound information and establish sufficient outbound information energy to maintain adequate information capacity within the corridor.

The FDA block depicts the correlation and synchronized up/down frequency conversion circuits 140, frequency reference pilot generation and SS generation circuit 142, frequency reference pilot and SS recovery circuit 144. While both master and slave subcircuits are shown, in practice only one or the other would be operating at one time in a given FDA.

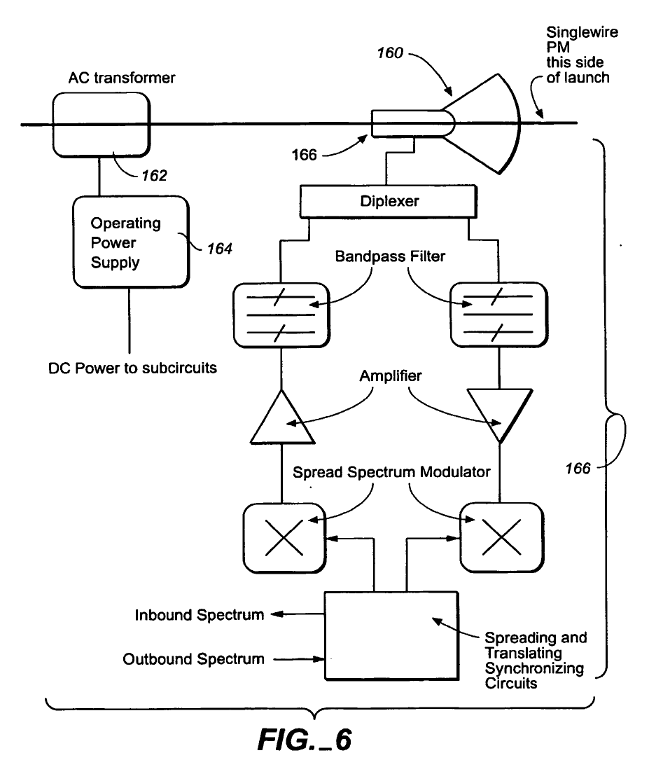

FIG. 6 is a schematic view showing detail of a singlewire PMA 160, AMP, dual-band FDA and SS. Also shown are operating power coupling 162 and PS circuits 164. The launch is shown attaching to a transmission line choke (RF choke assembly) 166 on the singlewire. This choke prevents ICE from flowing to the left in the drawing and allows all ICE in both bands to couple through the launch to the singlewire on the right. It may be implemented either with or without metallic contact. It may be fabricate with a longitudinal slot in the entire assembly to allow easy attachment to existing power lines.

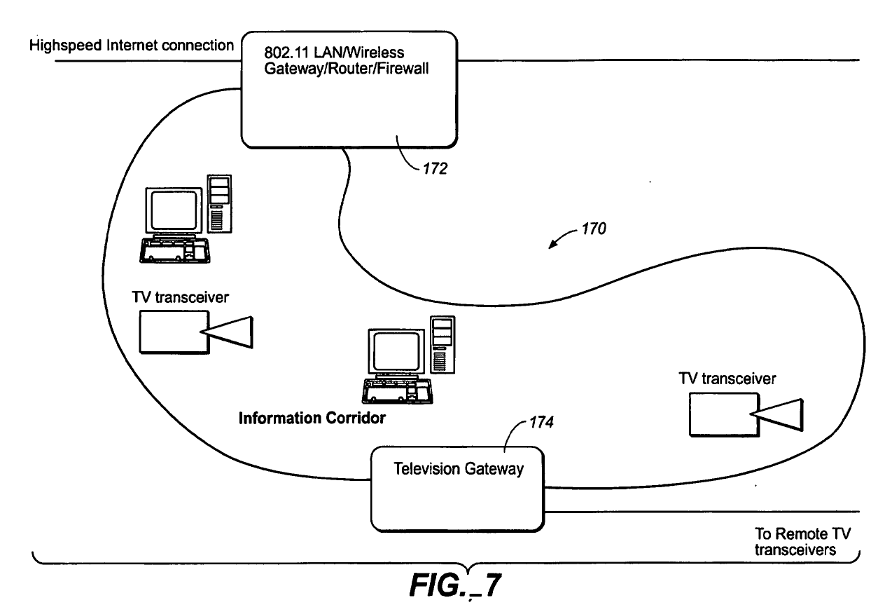

FIG. 7 is a schematic diagram of an information corridor 170 with gateways 172, 174 for different types of services.

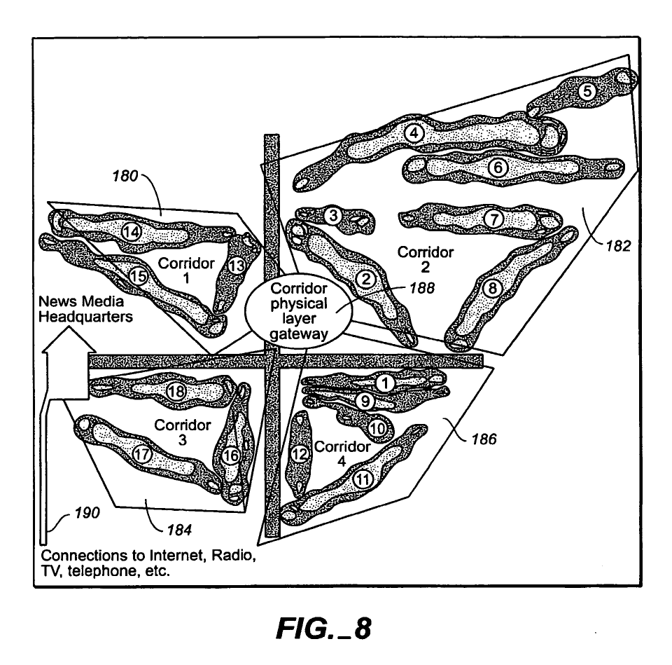

FIG. 8 is a schematic of separate information corridors 180, 182, 184, 186, temporarily merged together at a physical layer gateway 188 to form a single, larger, corridor, as well as some exemplary gateway devices 190.

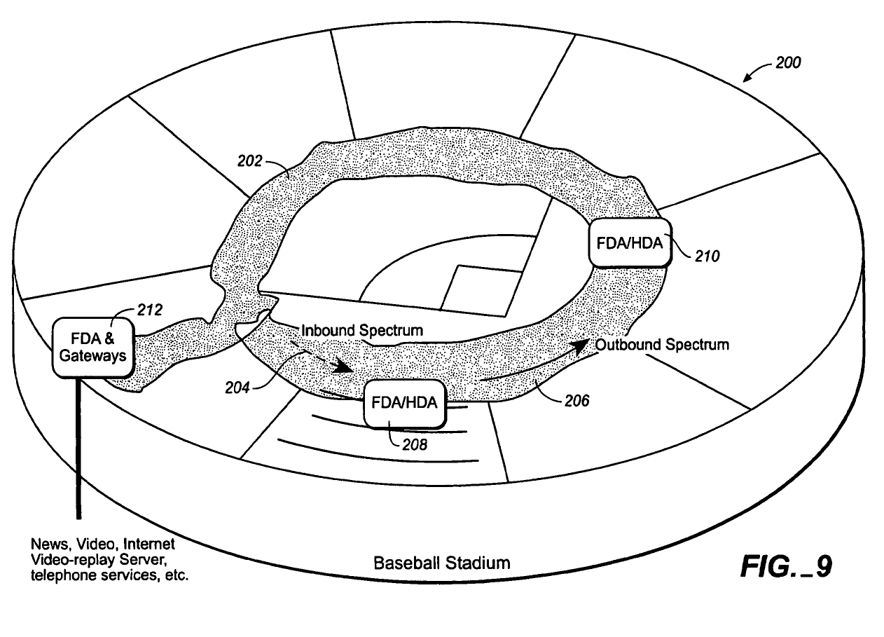

FIG. 9 shows an information corridor 200 implemented at a sporting event to distribute to spectators high capacity information services such as streaming audio, streaming video, internet access, “Instant Replay” on demand, telephone, and so forth. The corridor is shown constructed as a ring 202, with inbound spectrum 204 coming from the users' left and outbound spectrum 206 continuing to the right. By using multiple duplex adapters 208, 210, 212, with the degree of sharing of any single adapter limited to a select seating of users, services can be rendered economically. It is possible for several users to share an FDA or even an HDA in this arrangement. Sharing an HDA has the effect of interrupting all incoming information from the other sharing users whenever a single user sends outbound information. For this reason, except for economy of equipment, an FDA is a preferred adapter. Two lightly coupled separate or one dual PMA could be used here, one to couple inbound spectrum from the PM to the left and the other to couple outbound spectrum to the PM to the right.

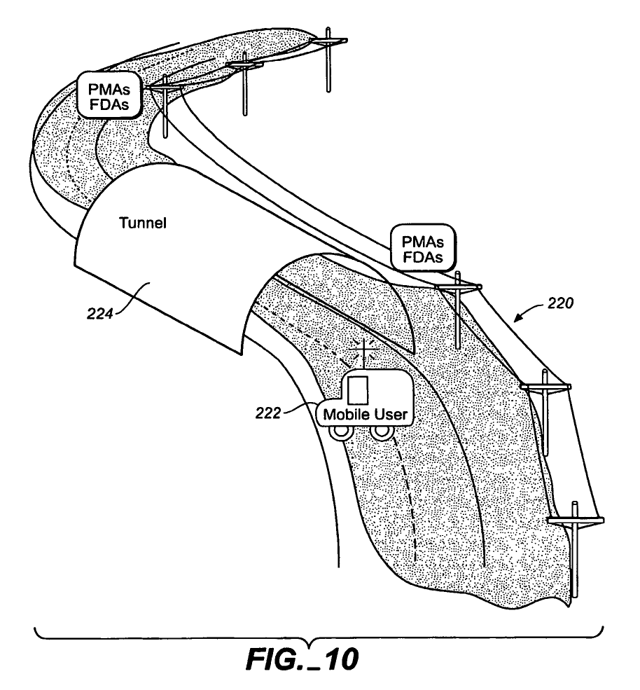

FIG. 10 shows an information corridor 220 being used to distribute services for mobile users 222. In addition to permitting high capacity information flow to and from users traveling over an open roadway, this arrangement can also provide coverage in and through tunnels 224 and other closed, shielded or shadowed spaces.

FIG. 11 shows an information corridor distributing information services among urban office environments and including corridor sections along highly traveled thoroughfares.

The corridor sections may be arranged to provide information exchange among different floors of a single building as well as between different buildings or campuses.

FIG. 12 is a schematic illustrating an information corridor 240 distributing traditional “last mile” information service to users 242 in a rural area by utilizing existing powerline 244 and wireless 246 sections to overcome incremental attenuation due to terrain and foliage. Because of the high capacity of such a system, it is possible to provide on-demand video services including analog and digital broadcast television, movies, and two-way television communications for education or health and security purposes.

Flexibility of implementation is a key feature of an information corridor and a single preferred embodiment is not optimum for all environments. In fact, it is this ability to adapt to the specific local circumstances and choice of implementation which allows the full benefits of an information corridor to be obtained. The selection of PM types and other particulars of a preferred embodiment will be determined by the terrain, existing PMs, resources, economics or other factors of a given locale. The example which follows is intended to illustrate the key components of one such preferred embodiment.

Example of a Preferred Embodiment

An example of a preferred MBE of the present invention is shown in FIG. 3. This figure shows a cascade of three different PM types; freespace, surfacewave, and wired. Also indicated are PMAs for these different PMs. Two examples of lightly-coupled PMAs are shown; one in a freespace PM and the other in a surfacewave PM. The surfacewave PMA might be implemented as described in U.S. Pat. No. 4,743,916, incorporated herein in its entirety by reference.

Freespace PM

Energy in this type of PM is propagated via freespace with conventional radio waves. The PMAs in this type are antennas which couple a spectrum of ICE to and from the “ether”. For optimum performance, multiple PMs of this type are arranged to be completely line-of-sight (hereafter referred to as LOS) to at least the 0.6 Fresnel zone for each PMA's location. AMP circuits are placed between the central antennas as shown in FIG. 4. This allows path losses between the antennas accessing a common PM to be restored to approximately free space loss values. Each antenna is selected to provide maximum directivity consistent with sufficient illumination of all the spatial region which it accesses. FIG. 4 illustrates interconnected freespace PMs.

AMP and FDA circuits for this PM are designed and constructed from conventional components using state-of-the-art techniques. Integrated circuitry and surface mount techniques are desirable here. Higher degrees of circuit integration may be beneficial.

An On-Channel Active Repeater (OCAR) using free space as a section of a corridor is also possible. For instance, an OCAR uses AMP circuits but not FDA circuits as a SBE. For such an OCAR, which is without frequency domain isolation, spatial isolation must be provided between antennas in order to allow proper AMP circuit operation and avoid oscillation. Isolation at least 10 dB in excess of AMP gains is normally required. Antenna directivity and judicial use of existing physical barriers are of great value to reduce the amount of physical distance required to achieve adequate isolation.

Surfacewave (Singlewire) PM

Energy in this type of PM is propagated via a surfacewave transmission line, which may also be known as “Goubau-line” or “G-line” and is referred to herein as “singlewire”. The PMAs in this instance are special launches capable of coupling conventional balanced, coaxial or wave-guide transmission lines to a surfacewave propagation mode in a PM of singlewire. When used in conjunction with HDAs or FDAs, as shown in FIG. 5, the PMAs provide dual-band operation and simultaneous bidirectional information transfer on singlewire. A preferred embodiment integrates the PMA with AMP, FIL, PMA, SS, FDA and power supply (PS) circuits which allow extraction of operating power from low frequency current flowing in the singlewire, which is part of an existing power mains grid. This allows self-contained operation and the entire assembly may “float” at the high line potential. FIG. 6 shows an example of one PMA and related circuits attached to a singlewire.

Wired (Including Coaxial and Fiber Optic Cables) PM

Energy in this type of PM is propagated via standard RF and microwave transmission lines, or by modulation of RF or microwave energy onto an optical carrier which is operated as a PMA with optical fiber transmission line. In the case of standard transmission lines PMAs are connectors or adapters and are used in conjunction with AMPs, FILs for SBE and/or FDAs for MBE. In the case of an optical fiber PM, PMAs incorporate electro-optical transducers in conjunction with AMPs, FILs for SBE and/or FDAs for MBE.

Construction: Propagation Media

Freespace: Construction of a freespace PM consists of selecting geographical antenna locations which provide essentially freespace path losses between PMAs (antennas) accessing a common PM. For optimum performance, a PM is arranged to have complete LOS to at least the 0.6 Fresnel zone for each accessing antenna's location. A single beam antenna can sometimes simultaneously access more than one PM, but multiple, beam-formed antennas are less wasteful of ICE and are preferred.

Singlewire: Singlewire PM is best constructed using single conductor wire or shielded cable which is best suspended in a manner which keeps the entire wire, and a region within a few wavelengths of the wire, clear of contact with or obstruction by any intervening obstacle. Such obstacles are typically trees, shrubs and parallel or crossing lines or wires. Existing power mains are excellent candidates. The wire conductor may either be insulated with a dielectric or uninsulated. Direct metallic contact between the wire conductor and the PMA is used unless an open-stub transmission line shorting method is utilized instead. A simple shorted transmission line choke is shown attaching to the singlewire in FIG. 6. Through inclusion of a longitudinal slot, the PMA may be easily attached to an existing line.

Wired Propagation Media: Wired PM is best constructed from conventional RF or microwave transmission line. The line should have sufficient bandwidth and low enough loss to maintain adequate information capacity between PMAs. Use of existing transmission lines having unused capacity, such as CATV cables, may be possible through the use of PMAs which include diplexer or similar frequency selective circuits.

Construction: Propagation Medium Adapters

In general PMAs are adapters which couple energy propagating in one type of PM into propagation in a different type of PM. Some common embodiments follow.

Freespace: Freespace PMAs are antennas which normally adapt conventional transmission lines or connector types to and from the freespace radio spectrum or “ether”. Freespace to singlewire PMAs may also be useful. The preferred embodiments utilize antennas with high aperture efficiency and as much directivity as is possible consistent with adequate illumination of the PM or PMs which are being accessed. More directivity and gain is possible when only a single section of corridor is being accessed. This focusing is desirable because it increases the information capacity of a given PM or allows use of a longer PM.

More complex, beam-forming arrays are desirable when a single freespace PMA serves corridor sectors located at different azimuths and elevations.

Singlewire: A singlewire PMA (hereafter referred to as LAUNCH) is an adapter which couples conventional transmission line, wave-guide or connector types to and from a surface wave flowing on a wire. Singlewire PMAs which couple to freespace are also possible. The LAUNCH is designed to operate efficiently over an entire band for SBE or more than one band for MBE. FIG. 6 shows an example LAUNCH for MBE.

Wired: Wired PMAs are usually transmission line connectors which allow the energy flowing in the preferred mode of a conventional RF or microwave transmission line or wave-guide to flow in a different type of conventional transmission line or waveguide. For MBE, frequency selective circuits, such as diplexers, should be included.

Amplifiers

Conventional amplifier and filtering circuits may be used. The requirements for the circuits include good linearity, reasonably low noise figure, and high dynamic range along with sufficient output power capability. Automatic gain control circuitry (AGC) may be provided to keep operation within a linear region, to provide good performance while avoiding unnecessary interference to other systems, to adjust for system variations, and to conform to regulation. It would be preferable to use a fast attack, slow decay AGC system with a loop bandwidth, which is low compared to the lowest signaling rate of the wireless devices being supported.

Frequency selective filtering should be designed to have low amplitude and group delay ripple over the desired spectrum being supported. Notch filtering and other special features may be added in some instances to reduce the near-far problem that can occur when one users' transmissions are significantly stronger than another's and would otherwise cause the AGC circuits to reduce system gain, but normally, such adjustments should be performed by protocols and hardware outside of the corridor.

Full Duplex Adapters

A preferred dual band FDA block diagram is shown in FIG. 5. This FDA includes synchronous frequency conversion circuitry 140 to allow bidirectional conveyance of the selected bandwidth while avoiding any frequency offset errors. It also includes SS modulation and demodulation circuits. FDAs using more than two bands are also possible.

FDAs are used in compatible groups of two or more types. Two types are used when only two bands are used for full-duplex. One FDA is considered the “master” in the sense that it establishes the frequency reference for frequency conversion as well as the reference for any SS modulation being used. The other type is considered a “slave” and synchronizes itself with the master's references, thereby enabling fully synchronous operation. This way, from the point-of-view of the wireless devices, the frequency conversions and the SS operation are invisible.

Half Duplex Adapters

HDAs resemble FDAs with the exception that simultaneous bidirectional operation is not supported. Eliminating this support can reduce complexity and construction cost for many applications.

Operation of Invention

Users intersecting and utilizing an information corridor at a PM not employing MBE may use the corridor directly. That is, they simply couple their wireless information device to the corridor, normally through the wireless device antenna or antennas. In some cases a directional antenna or special coupling device between the wireless device and an additional antenna may be desirable to provide adequate coupling or amplification. The wireless device is then operated normally. Because the wireless device interfaces to the spectrum in the same manner as it would without an information corridor, all protocols, collision detection and avoidance, error correction, modulation types and formats continue to operate normally. The enhanced capacity provided by the corridor transparently allows greater communication range and quality to the device and its applications.

Users intersecting and utilizing an information corridor at a PM which requires an HDA or FDA must themselves interface the corridor through a compatible duplex adapter. In this arrangement, there is an advantage to the operator of the information corridor in that access can be controlled and customer use can be billed. The user may couple to the FDA through a small coupling device that is included in the HDA or FDA or with the wireless devices' own antenna.

Systems of Information Corridors

In order to maximize economy and service, the total region within a given information corridor is normally chosen such that the corridor's total information capacity equals or exceeds the information requirements of all users, devices and applications which it serves. Gateway or bridge devices, which are protocol specific and not part of the corridor per se, are then added between a corridor and other information pathways, including other corridors, and serve to restrict information intended only for local destinations within a given corridor, to prevent it from traveling beyond the defined limits. These protocol-specific devices include physical layer protocol specificity in the form of circuits for modulation and demodulation of information within the corridor's supported frequency spectrum, and may also have mechanisms of higher layer specificity, such as traditional TCP/IP switches and routers, which can serve to determine and direct the information flow as required. An IEEE802.11 wireless gateway is an example of one such device. An example of a corridor with gateways for different types of services is shown in FIG. 7.

The need for control of corridor size and of information flow into and out of a corridor is analogous to the need for subnetting within TCP/IP networks, and it is used for the same reasons: namely, to maximize performance and economy while minimizing congestion. For this reason, information corridors may be “sub-netted” so that optimum functionality and economy to the local users and applications can be achieved.

Because information needs can vary over time and can occasionally shift from locality to locality over time, there are situations requiring that two or more separate corridors be temporarily merged at the physical layer to form a single, larger, corridor. In these situations, a physical layer gateway which joins the entire corridor with another may be used. An example is illustrated in FIG. 8, which schematically depicts the layout of a golf course. In such a venue, there are many news reporters, television cameras and spectators needing a large information capacity through a variety of services: telephones, internet access, bidirectional analog television communications links, and so forth. A variety of protocol-specific applications and wireless devices must be supported. With a multitude of live cameras spread out over the length of a very large golf course, several sub-netted information corridors might be arranged. In this manner, as the tournament progresses and the focus of activity moves from hole to hole, along with the crowd, individual corridors can be selectively combined and removed to form a larger single corridor in order to keep up with the total information requirements. Bi-directional communications and information flow for a variety of services can then be accommodated while maintaining an economy of corridor infrastructure.

While the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. An apparatus for bidirectional conveyance of a spectrum of guided or focused information-carrying electromagnetic signals, including at least first inbound and outbound spectrums and second inbound and outbound spectrums, for distribution among end users, including at least first and second end users, said apparatus comprising:
at least one propagation medium (“PM”); and
first and second propagation medium adapters (“PMAs”) coupled to said propagation medium.

2. An apparatus as in claim 1, wherein said apparatus is linear.

3. An apparatus as in claim 2, wherein said PM is an interior PM and said apparatus includes at least one PMA lightly coupled to said interior PM.

4. An apparatus as in claim 1, further including an amplification circuit interposed between said second propagation medium adapter and said first end user.

5. An apparatus as in claim 1, further including a filtering circuit interposed between said second propagation medium adapter and the first end user.

6. An apparatus as in claim 1, further including a half duplex adapter circuit interposed between said second propagation medium adapter and the first end user.

7. An apparatus as in claim 1, further including a full duplex adapter circuit interposed between said second propagation medium adapter and said first end user.

8. An apparatus as in claim 1, further including a spread spectrum modulation and demodulation circuit interposed between said second propagation medium adapter and said first end user.

9. An apparatus as in claim 1, wherein said propagation medium is selected from the group consisting of coaxial cable, dielectric waveguide, conductive waveguide, surfacewave transmission lines, and free space.

10. An apparatus as in claim 1, wherein said coupling comprises direct metallic contact.

11. An apparatus as in claim 1, wherein said coupling comprises non-metallic contact.

12. An apparatus as in claim 1, wherein said first propagation medium adapter is selected from the group consisting of antennas, surfacewave launches, waveguide connectors, coaxial connectors, and electro/optical transducers.

13. An apparatus as in claim 1, wherein said first and second inbound spectrums comprise electromagnetic radiation having wavelengths between 10 meters and 1 centimeter.

14. A method for bidirectional transmission of a spectrum of electromagnetic signals over a medium, said method comprising the steps of:
providing a propagation medium;
coupling first and second propagation medium adapters to said propagation medium;
delivering a first inbound spectrum to said first propagation medium adapter, through said propagation medium, and to said second propagation medium adapter; and
delivering a first outbound spectrum from said second propagation medium adapter to a first end user.

15. The method for bidirectional transmission of electromagnetic signals of claim 14 further including the steps of:
delivering a second inbound spectrum to said second propagation medium adapter, through said propagation medium, and to said first propagation medium adapter; and
delivering a second outbound spectrum from said first propagation medium adapter to a second end user.

16. The method for bidirectional transmission of electromagnetic signals of claim 14 further including the step of:
interposing at least one amplification circuit between a propagation medium adapter and an end user.

17. The method for bidirectional transmission of electromagnetic signals of claim 14 further including the step of:
interposing a filtering circuit between a propagation medium adapter and an end user.

18. The method for bidirectional transmission of electromagnetic signals of claim 14 further including the step of:
interposing a half duplex adapter circuit between a propagation medium adapter and an end user.

19. The method for bidirectional transmission of electromagnetic signals of claim 14 further including the step of:
interposing a full duplex adapter circuit between a propagation medium adapter and an end user.

20. The method for bidirectional transmission of electromagnetic signals of claim 14 further including the step of:
interposing a spread spectrum modulation and demodulation circuit between a propagation medium adapter and an end user.

21. The method for bidirectional transmission of electromagnetic signals of claim 14 wherein said propagation medium is selected from the group consisting of coaxial cable, dielectric waveguide, conductive waveguide, surfacewave transmission lines, and free space.

22. The method for bidirectional transmission of electromagnetic signals of claim 14 wherein said propagation medium adapters are selected from the group consisting of antennas, surfacewave launches, waveguide connectors, coaxial connectors, and electro/optical transducers.

24. The method for bidirectional transmission of electromagnetic signals of claim 14 wherein said first and second inbound spectrums comprises electromagnetic radiation having wavelengths of between 10 meters and 1 centimeter.

25. A method for transparent, simultaneous, and bidirectional conveyance of a spectrum of focused or guided electromagnetic signals among end users, including at least first and second end users, comprising the steps of:
providing at least one propagation medium (PM) suited for the intended environment of use, said PM selected from the group consisting of dielectric waveguide, conductive waveguide, coaxial transmission line, surface wave transmission line, and free space;
providing at least first and second propagation medium adapters (PMAs) for coupling at least one PMA to said PM between said PM and said end users, said PMAs selected from the group consisting of antennas, surfacewave launches, waveguide connectors, coaxial connectors, and electro/optical transducers;
delivering a first inbound spectrum to said first propagation medium adapter, through said propagation medium, and to said second propagation medium adapter;
delivering a first outbound spectrum from said second propagation medium adapter to the first end user;
delivering a second inbound spectrum to said second propagation medium adapter, through said propagation medium, and to said first propagation medium adapter; and
delivering a second outbound spectrum from said first propagation medium adapter to a second end user.

26. The method of claim 25, further including the step of interposing a duplex adapter circuit between each end user and each PMA, said duplex adapter circuits selected from the group consisting of half duplex adapters and full duplex adapters, said duplex adapter circuits including at least one circuit selected from the group consisting of frequency conversion circuits, amplifying circuits, filtering circuits, spread spectrum circuits, inbound/outbound switching circuits, and synchronizing circuits.

27. The method of claim 26, wherein at least one of said duplex adapters includes a spread spectrum circuit.

28. The method of claim 26, wherein at least one of said duplex adapters includes at least one synchronizing circuit.

29. The method of claim 26, wherein at least one of said duplex adapters includes a filtering circuit.

30. The method of claim 26, wherein at least one of said duplex adapters includes an amplification circuit.

31. The method of claim 26, wherein at least one of said duplex adapters is an HDA and includes at least one inbound/outbound switching circuit.

32. An apparatus for transparent, simultaneous, and bidirectional conveyance of a spectrum of focused and/or guided electromagnetic signals among end users, including at least first and second end users, said apparatus comprising:
at least one functional group of electronic components, each of said group in electromagnetic communication with at least one other functional group, if any, each of said functional groups including:
(a) at least one propagation medium (PM) selected from the group consisting of dielectric waveguide, conductive waveguide, coaxial transmission line, surface wave transmission line, and free space; and
(b) a first and second propagation medium adapter (PMAs) coupled to said PM and interposed between said PM and said end users, said PMAs selected from the group consisting of antennas, surfacewave launches, waveguide connectors, coaxial connectors, and electro/optical transducers;
a first inbound spectrum transmitted to said first propagation medium adapter, through said propagation medium, and to said second propagation medium adapter;
a first outbound spectrum from said second propagation medium adapter to a second end user;
a second inbound spectrum to said second propagation medium adapter, through said propagation medium, and to said first propagation medium adapter; and
a second outbound spectrum from said first propagation medium adapter to a first end user.

33. An apparatus as in claim 32, further including a duplex adapter circuit interposed between each end user and each PMA, said duplex adapter circuits selected from the group consisting of half duplex adapters and full duplex adapters.

34. An apparatus as in claim 33, wherein each of said duplex adapter circuits includes at least one frequency conversion circuit, at least one amplifying circuit, and at least one filtering circuit.

35. An apparatus as in claim 33, wherein each of said duplex adapter circuits includes a spread spectrum circuit.

36. An apparatus as in claim 33, including a plurality of functional groups.

37. An apparatus as in claim 36, wherein said plurality of functional groups is in a linear configuration.

38. An apparatus as in claim 36, wherein said plurality of functional groups is in a substantially linear configuration comprising first and second end groups and at least one interior group, and wherein at least one of said plurality of functional groups is coupled to an interior group.
